(19) United States
(12) Patent Application Publication
(10) Pub. No.: US 2011/0151192 A1
(43) Pub. Date: Jun. 23, 2011

(54) ELECTROSTATIC DISSIPATIVE ARTICLES AND METHOD OF MAKING

(75) Inventors: Christopher J. Reilly, Whitinsville, MA (US); Edmund A. Cortellini, North Brookfield, MA (US)

(73) Assignee: SAINT-GOBAIN CERAMICS & PLASTICS, INC., Worcester, MA (US)

(21) Appl. No.: 12/951,992

(22) Filed: Nov. 22, 2010

Related U.S. Application Data
(60) Provisional application No. 61/288,789, filed on Dec. 21, 2009.

(51) Int. Cl. C04B 35/565; B32B 5/16; C04B 35/56

(52) U.S. Cl. 428/143; 501/87; 501/92

(57) ABSTRACT

An electrostatic dissipative (ESD) article includes a body having a volume resistivity within a range between about 10⁴ ohm-cm and about 10¹⁰ ohm-cm as measured at 23° C. and 500 V. The body also has a first phase including a nitride, a second phase including a carbide, and a third phase including an oxide material.

### CROSS-REFERENCE TO RELATED APPLICATION(S)

The following disclosure is a non-provisional application which claims priority to U.S. Provisional Application No. 61/288,789 filed Dec. 21, 2009, entitled “Electrostatic Dissipative Articles And Method Of Making” and having named inventors Christopher J. Reilly and Edmund A. Cortellini, which application is incorporated by reference herein in its entirety.

### BACKGROUND

1. Field of the Disclosure

The following is directed to an electrostatic dissipative (ESD) article, and particularly an ESD article made of a nitrogen-bonded silicon carbide material having a particular volume resistivity.

2. Description of the Related Art

Silicon carbide-based ceramic materials have been utilized in refractory applications for their various refractory properties, including corrosion resistance, strength, thermal shock resistance, and thermal conductivity. Among various types of silicon carbide-based ceramics, dense silicon carbide ceramics such as sintered silicon carbide, hot pressed silicon carbide, and hot isostatically pressed silicon carbide have particularly robust characteristics. However, because of the production complexity and costs associated with fabrication of highly dense silicon carbide components (such as Hexoloy®), such components are not widely used as refractory components, and only used under the most severe service conditions. On the other hand, more cost effective but relatively porous silicon carbide materials such as nitride-bonded silicon carbide (known by acronyms such as NBSC and NSIC) have found practical use in refractory applications. Such refractory components include furnace or kiln furniture utilized in connection with holding or supporting work pieces during firing operations, as well as refractory lining materials and structural walls defining the furnace heating area.

Nitride-bonded silicon carbide tends to be a comparatively porous material, oftentimes having a porosity within a range of about 10 to about 15 vol %. These components are manufactured from a green body containing silicon carbide and silicon, and sintering the green body in a nitrogen containing atmosphere at temperatures on the order of 1,500° C. While nitride-bonded silicon carbide has desirable high temperature properties, it unfortunately suffers from poor oxidation resistance when used in oxidizing conditions, due in part to its intrinsic porosity. This particular characteristic has been addressed in the past by re-firing nitride-bonded silicon carbide components in an oxidizing atmosphere to form a thin oxide layer of amorphous or glassy silica, which functions to passivate and seal the outer surface of the component. Other techniques have focused on forming an outer, protective layer by firing a glass former, such as a silica-containing coating or a silica precursor, which is coated on the component. However, unfortunately, such processing pathways tend to form porous layers that have a propensity to crack and spall during use, rendering the outer protective layer of limited effectiveness.

In view of the state of the art of silicon carbide-based materials, and in particular, nitride-bonded silicon carbide components, there is a need in the art for improved components.

### SUMMARY

According to one aspect, an electrostatic dissipative (ESD) article includes a body having a volume resistivity within a range between about 10⁴ ohm-cm and about 10¹⁰ ohm-cm as measured between about 23° C. and about 400° C. at about 10 V. The body includes a matrix of at least three phases dispersed throughout the volume of the body including a first phase comprising a nitride, a second phase comprising a carbide, and a third phase comprising an oxide material.

In accordance with another aspect, an electrostatic dissipative (ESD) article has a body having a volume resistivity within a range between about 10³ ohm-cm and about 10¹⁰ ohm-cm as measured between about 23° C. and about 400° C. at about 10 V. The body includes three phases of grains dispersed within each other and bonded to each other, a first phase of grains comprising a nitride material, a second phase comprising a carbide material, and a third phase comprising an oxide material.

In yet another aspect, an electrostatic dissipative (ESD) article includes a substrate body including a working surface having a surface roughness (Rₐ) of not greater than about 40 microns, wherein the substrate body is a composite material including grains comprising a nitride material, grains comprising a carbide material, and grains comprising an oxide material dispersed within the grains comprising the nitride material and the grains comprising the carbide material.

According to still another aspect, an electrostatic dissipative (ESD) article includes a substrate body for supporting glass panels during processing, the substrate body has a volume resistivity within a range between about 10³ ohm-cm and about 10¹⁰ ohm-cm as measured between about 23° C. and about 400° C. at about 10 V and a working surface comprising a surface roughness (Rₐ) of not greater than about 40 microns. The substrate body includes a crystalline matrix phase comprising mullite.

In another aspect, a method of forming an ESD article includes forming a mixture including a silicon material, a carbon-containing material, and an oxide material comprising an aluminosilicate, forming the mixture to form a green article, and sintering the green article to form an article having a volume resistivity within a range between about 10³ ohm-cm and about 10¹⁰ ohm-cm as measured between about 23° C. and about 400° C. at about 10 V.

### BRIEF DESCRIPTION OF THE DRAWINGS

The present disclosure may be better understood, and its numerous features and advantages made apparent to those skilled in the art by referencing the accompanying drawings.

FIG. 1 is a flow chart providing a process of forming an ESD article in accordance with an embodiment.

FIG. 2 includes a scanning electron microscope image of a portion of an ESD article in accordance with an embodiment.

FIG. 3 includes a plot of 2-point volume resistivity versus amount of mullite substitution for four samples formed according to embodiments herein.

FIG. 4 includes a plot of 2-point volume resistivity versus temperature for samples formed according to an embodiment.

The use of the same reference symbols in different drawings indicates similar or identical items.

### DETAILED DESCRIPTION

The following is directed to electrostatic dissipative (ESD) articles and methods of forming such articles. The ESD articles may be used in various industries, including for example, for use as substrates for processing of workpieces thereon. In particular, the following ESD articles may be well suited for use in the manufacturing of electrical components, optoelectronic components, and other industries utilizing high temperature processing to form sensitive electronic components, including for example, but not limited to, the manufacturing of displays (e.g., plasma screens, liquid crystal displays, etc.).

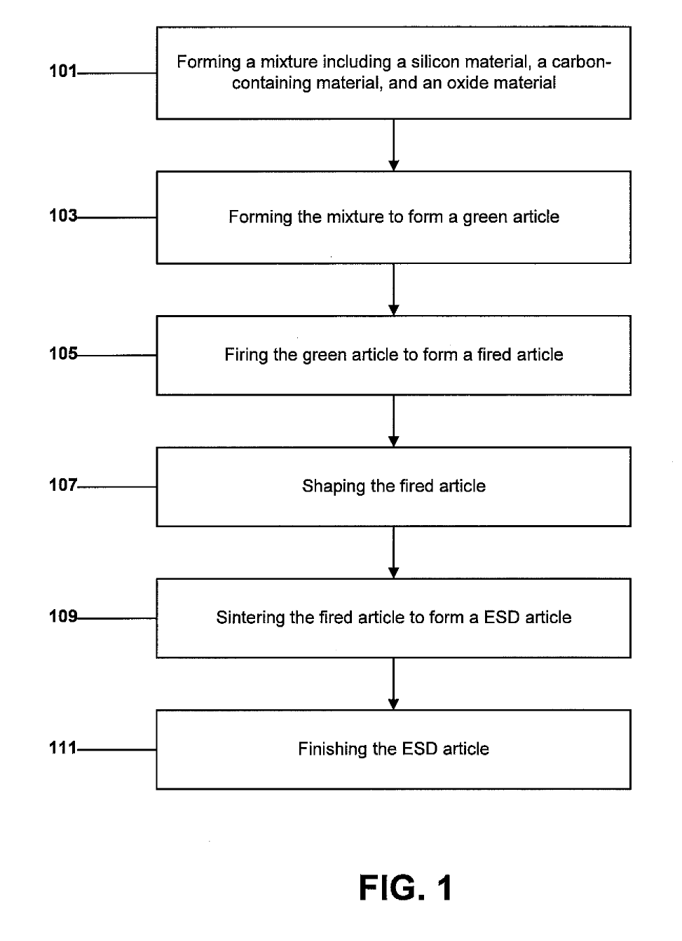

FIG. 1 includes a flow chart illustrating a process for forming an ESD article in accordance with an embodiment. As illustrated, the process can be initiated at step 101 by forming a mixture including a silicon material, a carbon-containing material, and an oxide material. In particular instances, the mixture may be a wet mixture. The wet mixture can be in the form of a slurry, including a liquid carrier and powder components of the materials noted above (i.e., the silicon material, carbon-containing material, and oxide material). In certain instances, the wet mixture can be a slurry utilizing an aqueous carrier material, which may be de-ionized water.

Additionally, it will be appreciated that other additives may be included within the mixture to control the rheology of the slurry. For example, a certain amount of stabilizers, pH modifiers, and/or dispersants may be added to control the rheology making the slurry suitable for the particular forming process.

It will be appreciated that the mixture can be formed by using particular types of dry powder components of the silicon material, carbon-containing material, and oxide material. According to one embodiment, the carbon-containing material can include a silicon carbide powder material, and more particularly, the carbon-containing material can consist essentially of a silicon carbide powder material.

The mixture can contain a certain amount of the carbon-containing material, such as at least about 15 wt %, such as at least about 25 wt %, at least about 30 wt %, or even at least about 35 wt % of the total weight of dry components contained within the mixture. In particular instances, the carbon-containing material can be present in an amount between about 15 wt % and about 80 wt %, such as between about 20 wt % and about 77 wt %, or even between about 30 wt % and about 77 wt % of the total weight of dry components within the mixture. Additionally, the carbon-containing material provided within the mixture can be a powder material having grains of an average grain size that is not greater than about 250 microns.

According to one embodiment, the silicon material within the mixture can be an elemental silicon metal powder. In particular instances, the elemental silicon metal power can consist essentially of silicon metal, such that it is 99.9% pure silicon.

The silicon material may be present in a particular amount within the mixture, such as not greater than about 40 wt %, or on the order of not greater than about 35 wt %, not greater than about 30 wt %, or even not greater than about 25 wt % of the total weight of dry powder components within the mixture. In particular instances, the mixture can contain between about 10 wt % and about 40 wt %, such as between about 10 wt % and about 35 wt %, between about 10 wt % and about 25 wt %, or even between about 10 wt % and about 20 wt % silicon material for the total weight of dry powder components within the mixture.

As noted herein, the silicon material can be an elemental silicon metal powder made of grains of silicon material. As such, in accordance with one embodiment the grains can have an average grain size of at least 10 microns, and particularly, between about 25 microns and 150 microns.

As described herein, the mixture can include an oxide material. In accordance with an embodiment, the oxide material can include an aluminosilicate material. Certain mixtures may utilize an aluminosilicate material that includes mullite (3Al₂O₃.2SiO₂), and more particularly, consists essentially of mullite. The oxide material, and particularly, the mullite material may be provided as a raw material in powder form within the mixture, facilitating the formation of an oxide matrix phase extending through the entire volume of the final-formed article. In other embodiments, the oxide material can include a purer form of aluminum-containing material than mullite, such as for example, alumina (Al₂O₃). That is, for example, the oxide material of the mixture can consist essentially of alumina.

In particular instances, the mixture can include an oxide material that can be a mixture of two or more oxide materials. The mixture of two or more oxide materials can be aluminum-containing oxide compounds. For example, in one embodiment, the oxide material can include a mixture of alumina (Al₂O₃) and mullite (3Al₂O₃.2SiO₂). In certain instances, the combination of oxide compounds in the oxide material can incorporate a majority content of alumina and a minority content of mullite. In other instances, the mullite material can be present in a majority amount and the alumina material can be present in a minor amount.

According to certain embodiments, the mixture can include at least about 10 wt %, such as at least about 12 wt %, at least about 15 wt %, at least about 20 wt %, at least about 25 wt %, or even at least about 30 wt % oxide material of the total weight of the dry components within the mixture. In accordance with one particular embodiment, the mixture is formed such that it contains between about 10 wt % and about 50 wt %, such as between about 10 wt % and about 45 wt %, or between about 10 wt % and about 40 wt % oxide material for the total weight of dry powder components within the mixture. For certain mixtures, the amount of the oxide may be within the low portion of the ranges described herein, such that particular mixtures can contain, between about 10 wt % and about 25 wt %, between about 10 wt % and about 20 wt %, between about 10 wt % and about 17 wt %, or even between about 10 wt % and 15 wt % of the oxide material for the total weight of dry powder components within the mixture. Still, in other particular instances, a higher concentration of oxide material may be used, and in such instances the mixture can contain between 25 wt % and about 50 wt %, such as between about 25 wt % and about 45 wt %, or even between about 25 wt % and about 40 wt % oxide for the total weight of dry components within the mixture.

As described herein, the oxide material can be a powdered oxide material, and more particularly a powdered mullite material, made of grains having an average grain size of not greater than about 50 microns, and particularly, between about 0.1 microns and 15 microns, or even between about 1.5 microns and about 15 microns.

In still other instances, minor amounts of particular oxide materials can be added to the mixture. For example, the mixture can include iron oxide. Certain suitable amounts of iron oxide can be minor amounts, such that the final body formed comprises an amount of iron oxide of not greater than about 3 wt % of the total weight of the mixture. In other instances, the amount of iron oxide within the mixture, and thus within the final body, can be not greater than about 2 wt % not greater than about 1 wt %, not greater than about 0.7 wt %, or even not greater than about 0.5 wt %. The mixture, and thus the final body, can have an amount of iron oxide within a range between about 0.01 wt % and about 3 wt %, such as between about 0.02 wt % and about 1 wt %, between about 0.08 wt % and about 0.8 wt %, or even between about 0.08 wt % and about 0.5 wt %.

After forming the mixture at step 101, the process can continue at step 103 by shaping the mixture to form a green article. In accordance with one embodiment, the shaping process can include a slip casting process wherein the slurry can be shaped into a body in a gypsum mold. Notably, the slurry can be poured into a plaster (gypsum) mold for casting, wherein the water within the slurry is drawn by capillary action through the gypsum mold, leaving behind a soft cast product, which can be referred to as a green article. The green article is an unfinished, unsintered ceramic part. For further details of the techniques for forming the ceramic body, attention is drawn to U.S. Pat. No. 4,990,469, incorporated herein by reference. While slip casting is generally used, other formation techniques used commonly in ceramic processing may also be used. For example, drip casting, pressing, pressure casting, extrusion, and other techniques.

Following slip casting, the green body can be removed from the mold and dried to remove any remaining water and give the green body additional strength. After shaping the mixture at step 103, the process can continue at step 105 by firing the green article to form a fired article. Typically, the green body is heated to a temperature greater than about 1,200° C. for a time period of at least 2 hours, and more particularly between about 2 to about 20 hours, depending upon the size of the body and the thickness of the wall of the body. Particular embodiments may be heat treated in a nitrogen-containing atmosphere at higher temperatures and longer durations, such as between about 1,200° C. and about 1,500° C., for at least 1 to 2 days. The firing of the ceramic body in the nitrogenous atmosphere can be effective to facilitate a reaction between the silicon material contained in the body and the nitrogen atmosphere, causing the formation of silicon nitride. The silicon nitride can be present within the fired body as a secondary phase, which bonds the primary silicon carbide phase.

After firing the article at step 105, the process can continue at step 107 by shaping the fired article. Shaping of the fired article can include removal of particular compositions and portions of the body of the fired article. In particular, shaping of the fired article can include removal of unwanted features and compositions from the external surfaces of the body of the fired article, since firing may result in a fired article having a “furry” external surface. Various methods can be undertaken to shape the fired article, including, for example, sand blasting, grinding, and other abrasive techniques.

After shaping the fired article at step 107, the process can continue at step 109 by sintering the fired article to form an ESD article. The sintering process can be a re-firing process, which is undertaken to densify all of the matrix, or at least portions of the matrix of the body of the ESD article. Sintering can be carried out at sintering temperatures of at least about 1,100° C., such as greater than about 1,200° C., or even greater than about 1,300° C. In fact, the sintering process can occur at substantially the same temperatures as the initial firing process.

The atmosphere during sintering can be an oxidizing atmosphere, which can include an ambient atmosphere comprising air. The durations for the sintering process can be at least about 2 hours, at least about 4 hours, at least about 6 hours. In certain instances, the duration of the sintering process (measured as the soak time at the firing temperature) can be between about 2 hours and about 20 hours, such as between about 5 hours and about 12 hours.

After sintering the fired article at step 109, the process can continue at step 111 by finishing the ESD article. Particularly suitable methods of finishing can include grinding and/or polishing procedures to form an ESD article having a body with particular size and contours as desired by the industry.

According to a particular embodiment, the finishing process can include removing a layer of material from an external surface of the body of the ESD article. The layer of material can include an amorphous material, such as a silica-containing material, which may be formed during the sintering process in the oxidizing atmosphere. Removal of the layer of material having the amorphous phase can facilitate formation of an ESD article having particularly desirable properties, including for example, but not limited to, a particular volume resistivity. Suitable methods for removing the layer of material can include abrasive techniques, including grinding, sand-blasting, and the like. According to one embodiment, the layer of material may be removed from essentially all exterior surfaces of the body of the ESD article.

Additionally, the finishing process can include shaping of the ESD article in the form of a substrate body having dimensions suitable for use in particular industries. For example, the finished ESD article may be formed such that it is generally in the shape of a substrate body having a length of about 0.5 meters. In fact, the ESD article may be a substrate body that has a length of at least about 0.75 meters, or even at least about 1 meter. Moreover, the ESD article can be in the form of a substrate body having a width (a measurement generally shorter than the length) that is on the order of at least about 0.25 meters, or even at least about 0.5 meters. Such large dimensions may facilitate the use of the ESD article in display manufacturing industries, such that it is suitable for supporting glass panels during processing of electronic components thereon.

Turning now to particular aspects of the final-formed ESD article, it will be appreciated that the article can generally be a nitrogen-bonded silicon carbide body. In particular, the ESD article can include at least three distinct phases that are dispersed within each other and extending throughout the entire volume of the body. In fact, each of the at least three distinct phases can be uniformly dispersed throughout the volume of the body to give the ESD article particular properties suitable for use in certain industries. Each of the three distinct phases can exist in the form of non-continuous phases, such that none of the three phases may necessarily be in the form of a continuous phase (e.g., a layer), each phase may exist as discrete particles, which are dispersed within the other phases, which can also be present as discrete particles. Notably, each of the three distinct phases can be crystalline phases. That is, each of the three distinct phases can consist essentially of crystalline materials, such that the body, as viewed in cross-section within an interior, is formed of three distinct types of crystalline grains dispersed within each other and bonded to each other.

In accordance with an embodiment, the ESD article can include a first phase comprising a nitride material. In particular, the nitride material can be silicon nitride. Moreover, particular embodiments may utilize a first phase that consists essentially of silicon nitride. The silicon nitride may be present throughout the volume of the body of the ESD article, and more particularly uniformly dispersed throughout the entire volume of the ESD article.

According to one design herein, the body contains a minority amount of the first phase comprising the nitride material. For example, the body can contain not greater than about 40 wt %, such as not greater than about 35 wt %, not greater than about 30 wt %, or even not greater than about 25 wt % of the first phase comprising the nitride material. In particular instances, the body can contain between about 10 wt % and about 40 wt %, such as between about 10 wt % and about 35 wt %, between about 10 wt % and about 25 wt %, or even between about 10 wt % and about 20 wt % of the nitride phase for the total weight of the body of the ESD article.

Moreover, the body of the ESD article can be formed such that the first phase including the nitride material, and more particularly the silicon nitride material, can have grains having an average grain size of at least about 10 microns. In other embodiments, the first phase can include grains of the nitride material having an average grain size of at least about 25 microns, such as at least about 30 microns, or even at least about 50 microns. In particular instances, the first phase can include grains of the nitride material having an average grain size within a range between about 10 microns and 200 microns, such as between about 10 microns and 150 microns, or even between about 25 microns and 150 microns.

The ESD article can be formed such that the body contains a second phase comprising a carbide material. In particular instances, the carbide material can be a silicon carbide material. The body can be formed such that the second phase, particularly the silicon carbide material, may be present in an amount that is greater than any other phase present within the body. For example, the silicon carbide within the body may be the majority phase, such that its content is greater than the content of the first phase comprising the nitride or a third phase comprising an oxide material.

In accordance with one embodiment, the second phase, which can include the silicon carbide material, can be present in an amount of at least 15 wt % of the total weight of the body. In other embodiments, the body can contain at least about 20 wt %, such as at least about 25 wt %, at least about 35 wt %, at least about 45 wt %, at least about 52 wt %, at least about 56 wt %, at least about 60 wt %, at least about 62 wt %, or even at least about 66 wt % of the second phase comprising the carbide material. Still, in particular instances the second phase comprising the carbide material can be present in an amount within a range between about 15 wt % and about 85 wt %, such as between about 25 wt % and 82 wt %, such as between about 35 wt % and 82 wt %, such as between about 45 wt % and 82 wt %, such as between about 50 wt % and 82 wt %, such as between about 55 wt % and 82 wt %, such as between about 60 wt % and 82 wt %, such as between about 65 wt % and 82 wt %, between about 70 wt % and 82 wt %, or even between about 75 wt % and about 82 wt %.

The second phase comprising the carbide material, and more particularly silicon carbide material, can have grains of carbide material having an average grain size that is greater than the average grain size of the material forming the first phase (e.g. nitride material). In fact, the material forming the second phase comprising the carbide material can have grains having an average grain size that is greater than the average grain size of any other material phase present within the body.

In alternative terms, the second phase including the carbide material, such as the silicon carbide material, can be formed of grains having an average grain size of not greater than about 250 microns. In other embodiments, the average grains size of the second phase, particularly the silicon carbide material can have an average grain size of not greater than about 200 microns, such as not greater than about 175 microns, or even not greater than about 150 microns. In particular instances, the second phase including the carbide material can include crystalline grains having an average grain size within a range between about 1 micron and about 250 microns, such as between about 25 microns and 200 microns, or even between about 50 microns and 150 microns.

In certain instances, the body can be formed to include silicon carbide grains having an irregular shape. In other instances, the body is formed such that the silicon carbide grains can have a generally rounded, that is, an equiaxed shape.

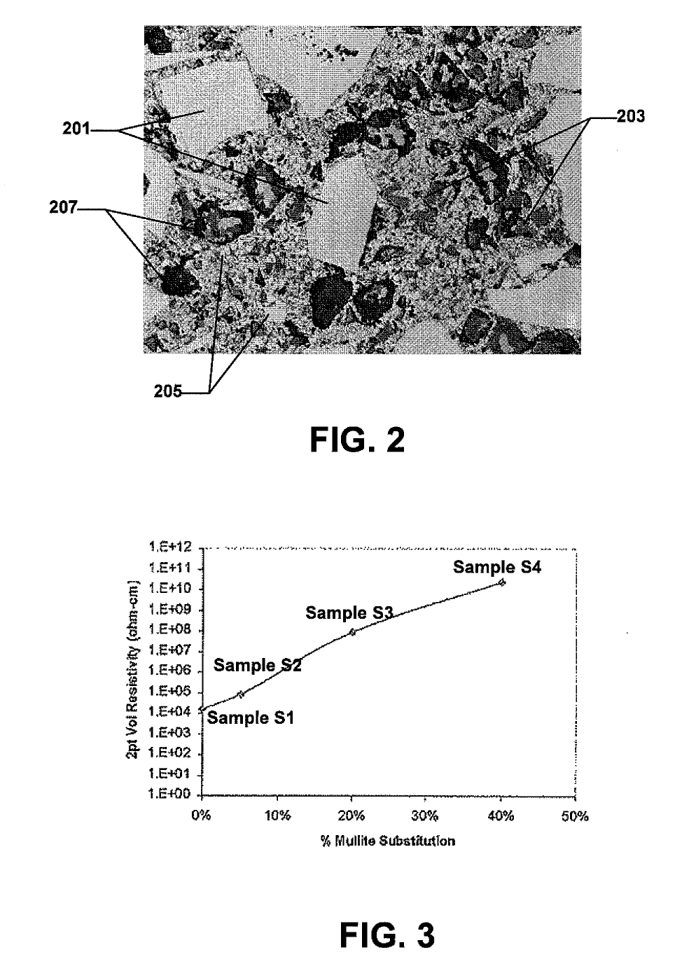

As illustrated in FIG. 2, the silicon carbide grains can be dispersed throughout the body of the ESD article. Moreover, the silicon carbide grains can be surrounded by smaller silicon nitride grains throughout the volume of the body, which may facilitate certain properties of the ESD article, including but not limited to, the volume resistivity of the body. Additionally, the silicon carbide grains and silicon nitride grains are covalently bonded compositions. Without wishing to be tied to a particular theory, it is noted that such covalently bonded compositions may mitigate electric charges building up in the body and are distinct from ionic bonded compositions (i.e., alumina), which have different charging properties and are theorized to cause greater charge build up in the body.

As described herein, the body of the ESD article can include a third phase of material comprising an oxide material. It will be appreciated that the oxide material can be dispersed within the matrix of the carbide material and nitride material such that it is uniformly dispersed throughout the entire volume of the body.

More particularly, the oxide material may be in the form of an amorphous phase that is dispersed between the first and second phases. For example, essentially all of the oxide material within the body can be in the form of an amorphous phase dispersed uniformly throughout the volume of the body. The oxide material may not necessarily be bonded to the crystalline first and second phases, facilitating the particular characteristics of the material as described herein. In particular instances, the oxide material can be a crystalline material having a generally orthorhombic crystalline structure.

The third phase can include grains of an oxide material that can be dispersed uniformly between the grains of the first phase and the grains of the second phase. Moreover, the grains of the third phase can include a single material, such as for example, mullite. In other instances, the grains of the third phase can include more than one oxide compound, including for example a combination of alumina and mullite.

In accordance with an embodiment, the body of the ESD article is formed such that the oxide material can be present in an amount that is equal to the amount of the second phase comprising the carbide material. In particular instances, the oxide material may be present within the body in an amount that is less than the amount of the second phase including the carbide material. Moreover, the oxide material of the third phase may be present throughout the body in an amount that is equal to the amount of the first phase. Still, in other embodiments the oxide phase can be present in an amount within the body that is greater than the amount of the first phase including the nitride material within the body.

In more particular terms, the body can be formed such that the third phase including the oxide material can be present in an amount of at least about 10 wt % of the total weight of the body. In other instances, this amount can be greater, such as at least about 12 wt %, at least about 14 wt %, at least about 15 wt %, at least about 17 wt %, at least about 20 wt %, such as at least about 25 wt %, such as at least about 30 wt %, or even at least about 35 wt %. In particular instances, the body can contain an amount of the third phase including the oxide material that is within a range between about 10 wt % and about 50 wt %, such as on the order of between about 10 wt % and about 45 wt %. For certain bodies, the amount of the oxide material may be within a low portion of the ranges described herein, such that particular bodies can contain, between about 10 wt % and about 25 wt %, between about 10 wt % and about 20 wt %, between about 10 wt % and about 17 wt %, or even between about 10 wt % and 15 wt % oxide material for the total weight of the body. Still, in other particular instances, a higher concentration of oxide material may be used, and in such instances, the body can contain between about 25 wt % and about 50 wt %, such as between about 25 wt % and about 45 wt %, or even between about 25 wt % and about 40 wt % oxide for the total weight of dry components within the mixture.

As described herein, the third phase can include an oxide material, which is a crystalline material, and defined by grains of material within the body. The oxide material can include grains having an average grain size that is smaller than the average grain size of the grains of the first phase including the nitride material. In other instances, the oxide material can have grains having an average grains size that is smaller than the average grain size of the grains of the second phase including the carbide material.

In more particular terms, the third phase including the oxide material can utilize grains having an average grain size of not greater than about 50 microns. In other instances, the oxide material may have smaller grains, having an average grain size of not greater than about 25 microns, such as not greater than about 15 microns, or even not greater than about 10 microns. Particular embodiments herein may utilize an oxide material having an average grain size within a range between about 0.1 microns and about 25 microns, such as about 0.1 microns and about 15 microns, between 1.5 microns and about 15 microns, or even between about 1 micron and about 10 microns.

Moreover, the third phase including the oxide material may utilize a crystalline phase of oxide material (e.g., mullite), wherein the grains have an irregular shape. In certain instances, the oxide material can have grains of a particular aspect ratio, which is a measurement of the dimensions of length to width (length:width). As such, the oxide material of some embodiments can have an aspect ratio of not greater than about 1.5:1. In more particular instances, the oxide material can include grains that are substantially equiaxed, which is, generally rounded in shape.

As described above, the body can include a minor amount of iron oxide. In particular, the body can contain an amount of iron oxide, which is the same as the weight percentages of iron oxide within the mixture, as described herein. The iron oxide can be incorporated into the third phase of material including the oxide material. For example, content of iron oxide within the body can be incorporated into grains of the material or at the grain boundaries of the other phases. In particular instances, the iron oxide can be incorporated into the grains of silicon nitride within the body. Alternatively, the body may be formed to have an amorphous phase, and the iron oxide may be preferentially disposed within the amorphous phase content of the body.

FIG. 2 includes a cross-sectional scanning electron microscope (SEM) image of a portion of a body of an ESD article take at 200×. The image illustrates the three distinct crystalline phases of the body 200. FIG. 2 demonstrates grains of silicon carbide 201, grains of silicon nitride 203, and grains of the mullite 205 dispersed within each other and bonded to each other within the body 200. The grains of the silicon carbide 201 are significantly larger than the grain of silicon nitride 203 and the grains of mullite 205. Moreover, the grains of the silicon nitride 203 are illustrated as being generally irregularly shaped or equiaxed, which is rounded in shape. The grains of silicon nitride 203 and grains of mullite 205 form the majority the matrix of the body 200 and are bonded to each other in a manner to form a bond posts connecting and bonding the larger grains of silicon carbide 201 to each other. Additionally, the grains of mullite 205 are substantially equiaxed (i.e., rounded), whereas the grains of silicon carbide 201 appear irregular in shape having flat edges joined at sharp corners. The body 200 further demonstrates pores 207 dispersed throughout the interior of the body 200 and having generally rounded shape and generally existing as closed porosity, that is, discrete isolated pores 207.

In accordance with embodiments herein, the final-formed nitrogen-bonded silicon carbide body can be a monolithic body utilizing three distinct phases of material which are dispersed within each other, and more particularly having a body that may be free of certain elements, compounds, and/or complexes. For example, in accordance with one embodiment the body of the ESD article can be essentially free of elemental metal species. Elemental metal species are unbonded species or elements which do not form compounds or complexes within the body of the ESD article. More particularly, the body can be essentially free of elemental transition metal elements as denoted in the Periodic Table of Elements.

In accordance with another embodiment, the body can be formed such that it is essentially free of elemental aluminum, which is aluminum which is not bonded to any other particular elements to form a complex and/or compound. Still, the body can be formed such that it is also essentially free of aluminum nitride (AlN). Moreover, the body of the ESD article can be essentially free of elemental boron. In fact, certain embodiments are free of boron, either as an elemental form, or as part of a compound or complex (e.g., an oxide, carbide, nitride, or boride). Additionally, the body of the ESD article can be formed such that it is essentially free of elemental carbon. Reference herein to materials to which are essentially free from the body is reference to materials that are present in amounts of less than 0.1 wt % of the total weight of the body of the ESD article.

The body of the ESD article can be formed to have particular amounts of porosity. For example, the body can have a porosity of at least 2 vol % for the total volume of the body of the ESD article. In other instances, the porosity can be greater, such as at least 5 vol %, at least about 10 vol %, or even at least about 12 vol % of the total volume of the body. Still, the porosity of the body can be within a range between about 2 vol % and about 20 vol %, such as between about 5 vol % and 15 vol %, or even between about 10 vol % and 15 vol %.

As described herein, the body of the ESD article can be shaped such that it is suitable for use as a substrate for supporting workpieces that may be used in display manufacturing processing. As such, the body of the ESD article can be in the form of a substrate having a working surface, configured to engage a workpiece, and therefore has particular features, such as dimensional characteristics, contours, and particle generation features which are suitable for use in the industry. For example, in one instance, the body can have a working surface having a particular surface roughness (Rₐ). In accordance with one design, the body is a substrate having a working surface, wherein the working surface has a surface roughness of not greater than about 40 microns. In other instances, the working surface can have a surface roughness that is not greater than about 30 microns, such as not greater than about 20 microns, not greater than about 10 microns, or even not greater than about 1 micron. Still, particular embodiments may utilize a ESD article in the form of a substrate having a working surface that has a surface roughness within a range between 0.01 microns and about 40 microns, such as between about 0.01 microns and about 20 microns, or even between about 0.1 microns and about 10 microns.

Moreover, in the context of an ESD article for use as a substrate, it will be appreciated that the working surface can be processed such that it has a porosity that is different than the volume % porosity of the entire body as described herein. In particular, an external surface of the body, such as the working surface, can have a coating, wherein the coating provides a region of the body that has a greater density than other regions of the body without the coating. For example, the porosity of the working surface including the coating may be not greater than about 10 vol %, such as not greater than about 8 vol %, not greater than about 5 vol %, or even not greater than about 2 vol %. Notably, a body having a working surface of such density may limit particle generation.

The coating can be formed through a deposition process (e.g. CVD process), spraying process (e.g., thermal spraying), and a combination thereof. As such, the working surface of the substrate body can be formed to include an inorganic material that may be deposited on the external upper surface of the body of the ESD article. Certain suitable coating materials can include inorganic materials, such as oxides, carbides, nitrides, borides, and a combination thereof.

As further described herein, the body of the ESD article can having dimensions suitable for use in the display manufacturing industry. Accordingly, the body of the ESD article may have a length and width as described herein, which facilitates supporting large glass workpieces.

In accordance with one embodiment, the body of the ESD article can be formed to have a particular volume resistivity, such that it may be used as a substrate in the processing of delicate electronic components. For example, the body can have a volume resistivity within a range between about 10⁴ ohm-cm and about 10¹⁰ ohm-cm as measured between about 23° C. and about 400° C. at about 10 V using a 2-point probe testing procedure. In other instances, the electrical characteristics may be slightly different, such that the body can have a volume resistivity within a range between about 10⁴ ohm-cm and about 10⁹ ohm-cm, such as between about 10⁴ ohm-cm and about 10⁸ ohm-cm, such as between about 10⁵ ohm-cm and about 10⁹ ohm-cm, such as within a range between 10⁵ ohm-cm and about 10⁸ ohm-cm, or within a range between about 10⁶ ohm-cm and about 10¹⁰ ohm-cm, or within a range between about 10⁶ ohm-cm and about 10⁹ ohm-cm, or even within a range between about 10⁶ ohm-cm and about 10⁸ ohm-cm as measured between about 23° C. and about 400° C. at about 10 V. Such values may also be suitable over a wider range of voltages, such as voltages between about 10 V and about 500 V, between 10 V and about 400 V, between about 10 V and about 300 V, between about 10 V and about 200 V, or even between about 10 V and about 200 V.

In certain instances, the body can contain a minor amount of iron oxide. For example, the amount of iron oxide can be not greater than about 2500 parts per million (ppm), such as not greater than about 2000 ppm, not greater than about 1800 ppm, not greater than about 1500 ppm, or even not greater than about 1000 ppm. Particular bodies according to examples herein can have an amount of iron oxide within a range between about 10 ppm and about 2500 ppm, such as between about 100 ppm and about 2000 ppm, such as between about 100 ppm and about 1800 ppm, or even between about 100 ppm and about 1000 ppm. Still, certain bodies can be essentially free of iron oxide, such that no detectable amount of iron oxide is present, which may be less than about 10 ppm.

For bodies having the particular content of iron oxide identified above, the volume resistivity of such bodies may be within a range between about 10⁴ ohm-cm and about 10⁷ ohm-cm as measured between about 23° C. and about 400° C. at about 10 V using a 2-point probe testing procedure. In other instances, the volume resistivity may be within a range between about 10⁵ ohm-cm and about 10⁷ ohm-cm as measured between about 23° C. and about 400° C. at about 10 V.

Testing of the volume resistivity for articles of the embodiments herein was based upon ASTM D 257, and testing was carried out using a 6517A Electrometer commercially available from Keithley. During testing, a voltage is applied across the sample, and an ammeter is used to measure the current passing through the sample. Voltage polarity alternates every 60 seconds for six minutes. Given the applied voltage, measured current, electrode area, and sample thickness, the DC volume resistivity can be calculated. Reported resistivity values are an average of positive and negative voltages applied to sample. All of the samples were tested at an applied voltage of 10V, and some of the samples were tested at higher voltages of 100V and/or 500V.

The body of the ESD article may have particular mechanical characteristics. For example, the body can have a modulus of rupture (MOR) as measured at room temperature according to the three point loading regime as outlined by ASTM C-133 of not greater than about 275 MPa. In other instances, the MOR may be less, such as not greater than about 250 MPa, not greater than about 225 MPa, not greater than about 200 MPa, or even not greater than about 150 MPa. In particular embodiments, the MOR of the body can be within a range between about 50 MPa and about 250 MPa, such as between about 80 MPa and about 225 MPa, or even between about 80 MPa and about 190 MPa.

Additionally, the body of the ESD article can have a particular density. According to one embodiment, the body can have a density that is between about 2.00 g/cm³ and about 3.00 g/cm³, such as between about 2.20 g/cm³ and about 2.90 g/cm³, or even between about 2.20 g/cm³ and about 2.75 g/cm³.

The bodies formed according to embodiments herein are polycrystalline bodies, having a plurality of grains of at least two different phases, wherein at least two of the phases are covalently bonded compositions. Additionally, the oxide material may be present as a crystalline phase disposed between the grains of the silicon carbide and silicon nitride. However, the oxide material may not necessarily be covalently bonded to the other phases, and instead may exhibit some ionic bonding to the other phases present. Conventional materials in the industry of ESD dissipative substrates generally utilize other materials having a high degree of ionic bonding characteristics. While not fully understood and not wishing to be tied to a particular theory, the bodies described in accordance with embodiments herein have notably reduced charge building characteristics compared to conventional ESD materials, and it is theorized that the monolithic and covalently bonded polycrystalline bodies behave differently than conventional ESD materials exhibiting a high degree of ionic bonding characteristics.

### EXAMPLES

### Example 1

Four samples (Standard, S2, S3, and S4) were prepared having various amounts of an oxide phase comprising various amounts of mullite and/or alumina, and each of the samples were tested for electrical characteristics. Samples S2-S4 were prepared according to embodiments herein, notably including three distinct phases dispersed throughout the body including silicon carbide grains, silicon nitride grains, and grains of an aluminosilicate (i.e., mullite). The amount of the aluminosilicate phase was altered in each of the samples to determine the effects on certain electrical characteristics.

Table 1 below provides a batching recipe, wherein the values are provided in weight percents for a dry powder mixture formed for each of the four samples (Standard and S2-S4). Notably, the Standard sample has no mullite content, but utilizes a certain content of casting grade alumina. Each of the other samples (i.e., S2, S3, and S4) have a certain content of mullite, and in fact, the content of mullite increases from a content of approximately 5 wt % in Sample 2 to a content of about 35 wt % in Sample 4. Additionally, as provided in Table 1, the content of mullite is substituted for the content of silicon carbide green having an average particle size of about 3 microns. In Sample 4, the content of mullite in the dry powder mixture is substituted for a portion of both silicon carbide powders, the large particle silicon carbide green having an average particle size of 150 microns and a portion of the silicon carbide green having an average particle size of 3 microns. Moreover, it should be noted that for Samples S2-S4, the amount of casting grade alumina is decreased. Each of the samples were formed into a slurry using a suitable amount of deionized water and additives (e.g., flocculants) if necessary.

TABLE 1

| | Standard | Sample 2 | Sample 3 | Sample 4 |
|---|---|---|---|---|
| SILICON CARBIDE | 37.5 | 39.18 | 37.14 | 31.79 |
| GREEN (~150 | | | | |
| microns) (wt %) | | | | |
| SILICON CARBIDE | 40.0 | 33.51 | 20.97 | 13.46 |
| GREEN (~3 microns) | | | | |
| (wt %) | | | | |
| Red Iron Oxide (wt %) | 0.5 | 0.49 | 0.46 | |
| Casting Grade Alumina | 5.0 | 4.91 | 4.66 | 3.98 |
| (wt %) | | | | |
| Mullite (wt %) | 0 | 6.08 | 20.97 | 35.90 |
| Silicon metal (~75 | 12.0 | 16.67 | 15.80 | 14.88 |
| microns) (wt %) | | | | |

FIG. 3 includes a plot of 2-point volume resistivity versus amount of mullite added to the body of the samples for the four samples formed. As indicated in FIG. 3, the volume resistivity of the body increased with increasing content of mullite, indicating that the mullite phase had an effect on the volume resistivity of the formed article. Notably, the Standard sample, having no mullite substitution and representative of conventional nitrogen bonded silicon carbide bodies, demonstrated an unsatisfactory volume resistivity. Samples S2-S4 demonstrated improved volume resistivity for use as ESD articles, and particularly Samples S2 and S3 demonstrated most suitable volume resistivity values.

The volume resistivity of each of the samples (Standard and S2-S4) was measured based upon ASTM D 257, and testing was carried out using a 6517A Electrometer commercially available from Keithley at approximately 23° C. at 10 V. Testing was carried out according to the procedures outlined in the description.

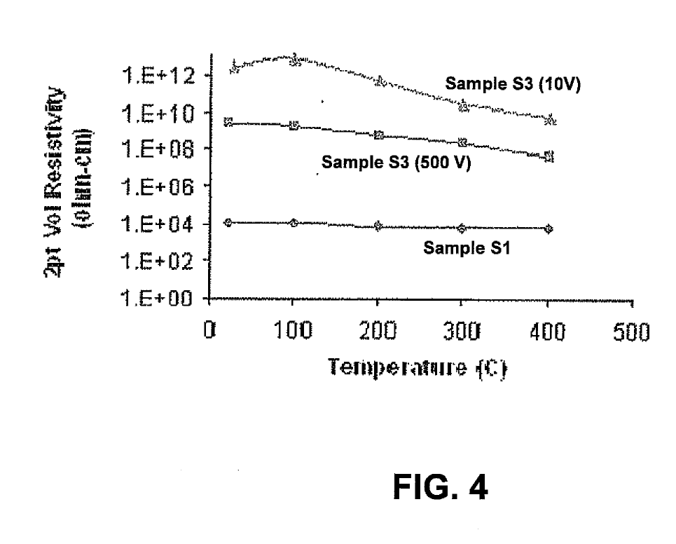

FIG. 4 includes a plot of 2-point volume resistivity versus temperature for the Standard sample and sample S3. The 2-point volume resistivity was measured as described herein. As illustrated in FIG. 4, the samples S3 formed according to an embodiment herein demonstrate values of volume resistivity over the range of temperatures from approximately 23° C. to 400° C. that are suitable for ESD applications. By contrast, the Standard sample demonstrates a volume resistivity that, while substantially unchanged over the range of temperatures, is less suitable for use in ESD applications. In fact, sample S3 demonstrated suitable volume resistivities over the range of temperatures for measurements conducted at 10 V and 500 V, voltages that differ from each other by more than an order of magnitude, thus demonstrating the ESD capabilities of the material for a wide range of voltages.

### Example 2

Two more samples are prepared (Sample 5 and Sample 6) having various amounts of the component materials as set forth in Table 2 below. Sample 5 and 6 are prepared according to the processing methods of the embodiments herein and include three distinct phases dispersed throughout the body including silicon carbide grains, silicon nitride grains, and grains of alumina. A Standard sample is also incorporated for comparison purposes. The Standard sample is commercially available as “Advancer” silicon carbide material from Saint-Gobain Corporation.

Table 2 below provides a batching recipe, wherein the values are provided in weight percents for a dry powder mixture formed for each of the samples. Notably, none of the samples incorporate mullite, and instead incorporate casting grade alumina for essentially the entire amount of the oxide material within the mixture and the body. Samples 5 and 6 are different than the Standard sample in terms of the silicon nitride material that is present, the amount of alumina material present, and/or the amount of fine-grained silicon carbide material that is present.

Table 2 also provides 2-point and 4-point resistivity testing results for each of the samples. As evident, the volume resistivity for Samples 5 and 6 is suitable for the wide range of voltage values tested for both 2-point and 4-point tests, making them particularly suitable for optoelectronic device manufacturing. The Standard sample was not able to provide a suitable result for testing at 100 V for the two-point probe test.

TABLE 2

| | Standard | Sample 5 | Sample 6 |
|---|---|---|---|
| SiC (3 Micron) | 37.5% | 42.5% | 37.5% |
| SiC (150 | 40.0% | 40.0% | 40.0% |
| Microns) | | | |
| Alumina | 5.0% | 5.0% | 10.0% |
| Silicon metal | 17.0% | 12.0% | 12.0% |
| (~75 microns) | | | |
| Voltage (V) | NA | 100.0 | 100.0 |
| Resistivity (2 pt) | NA | 1.46E+06 | 1.77E+07 |
| Voltage (V) | 10.0 | 10.0 | 10.0 |
| Resistivity (2 pt) | 5.45E+06 | 5.04E+07 | 3.00E+08 |
| Resistivity (4 pt) | 3.75E+05 | 5.84E+06 | 1.32E+07 |
| Density (g/cc) | 2.73 | 2.69 | 2.73 |

The embodiments herein are directed to ESD articles incorporating silicon carbide, silicon nitride, and an oxide material having particular electrical characteristics making the article suitable for use in manufacturing electronic components. The embodiments herein are directed to a combination of features including the percentages of particular phases within the body, size of grains within the body, dispersion of the phases, absence of certain materials (i.e., elements and/or compounds), porosity, dimensional characteristics, surface features (e.g., Rₐ), and others that represent a departure from the state of the art. The embodiments provide a combination of features, which can be combined in various manners to describe and define the bonded abrasive articles of the embodiments. The description is not intended to set forth a hierarchy of features, but different features that can be combined in one or more manners to define the invention.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The disclosure is submitted with the understanding that it will not be used to interpret or limit the scope or meaning of the claims. In addition, in the foregoing disclosure, various features may be grouped together or described in a single embodiment for the purpose of streamlining the disclosure. This disclosure is not to be interpreted as reflecting an intention that the embodiments herein limit the features provided in the claims, and moreover, any of the features described herein can be combined together to describe the inventive subject matter. Still, inventive subject matter may be directed to less than all features of any of the disclosed embodiments.

1. An electrostatic dissipative (ESD) article comprising:
a body having a volume resistivity within a range between about 10⁴ ohm-cm and about 10¹⁰ ohm-cm as measured between about 23° C. and about 400° C. at about 10 V, the body including a matrix of at least three phases dispersed throughout the volume of the body comprising:
a first phase comprising a nitride;
a second phase comprising a carbide; and
a third phase comprising an oxide material.

2. The ESD article of claim 1, wherein the body has a volume resistivity within a range between about 10⁴ ohm-cm and about 10⁹ ohm-cm as measured between about 23° C. and about 400° C. at about 10 V.

3. The ESD article of claim 2, wherein the body has a volume resistivity within a range between about 10⁴ ohm-cm and about 10⁸ ohm-cm as measured between about 23° C. and about 400° C. at about 10 V.

4. The ESD article of claim 3, wherein the body has a volume resistivity within a range between about 10⁵ ohm-cm and about 10⁸ ohm-cm as measured between about 23° C. and about 400° C. at about 10 V.

5. (canceled)

6. The ESD article of claim 1, wherein the first phase comprises silicon nitride.

7. The ESD article of claim 6, wherein the first phase comprises grains of silicon nitride having an average grain size of at least about 10 microns.

8-10. (canceled)

11. The ESD article of claim 1, wherein the first phase is present in an amount of not greater than about 40 wt % of the total weight of the body.

12-14. (canceled)

15. The ESD article of claim 1, wherein the second phase comprises silicon carbide.

16. The ESD article of claim 15, wherein the second phase comprises grains of silicon carbide having an average grain size of not greater than about 250 microns.

17-20. (canceled)

21. The ESD article of claim 1, wherein the second phase comprises grains having an irregular shape.

22. The ESD article of claim 1, wherein the second phase is present in an amount of at least about 15 wt % of the total weight of the body.

23-26. (canceled)

27. The ESD article of claim 1, wherein the third phase comprises an oxide material selected from the group of oxide materials consisting of alumina, silica, and a combination thereof.

28. The ESD article of claim 1, wherein the third phase comprises an oxide compound including alumina and silica.

29. The ESD article of claim 28, wherein the third phase comprises mullite (3Al₂O₃.2SiO₂).

30. The ESD article of claim 29, wherein the third phase consists essentially of mullite.

31-34. (canceled)

35. The ESD article of claim 1, wherein the third phase comprises grains having an average grain size smaller than an average grain size of grains of the first phase.

36. The ESD article of claim 1, wherein the third phase comprises grains having an average grain size smaller than an average grain size of grains of the second phase.

37-46. (canceled)

47. The ESD article of claim 1, wherein the body comprises a nitrogen-bonded silicon carbide material.

48. (canceled)

49. The ESD article of claim 1, wherein the body further comprises iron oxide.

50-67. (canceled)

68. An electrostatic dissipative (ESD) article comprising:
a monolithic body having a volume resistivity within a range between about 10³ ohm-cm and about 10¹⁰ ohm-cm as measured between about 23° C. and about 400° C. at about 10 V, the monolithic body comprising three phases of grains dispersed within each other and bonded to each other, a first phase of grains comprising a nitride material, a second phase comprising a carbide material, and a third phase comprising an oxide material.

69-73. (canceled)

74. The ESD article of claim 68, wherein the body is essentially free of AlN.

75-80. (canceled)

81. An electrostatic dissipative (ESD) article comprising:
a substrate body including a working surface having a surface roughness (Rₐ) of not greater than about 40 microns, wherein the substrate body is a composite material comprising:
grains comprising a nitride material;
grains comprising a carbide material; and
grains comprising an oxide material dispersed within the grains comprising the nitride material and the grains comprising the carbide material.

82-111. (canceled)
